(19) United States
(12) Patent Application Publication
(10) Pub. No.: US 2004/0120220 A1
(43) Pub. Date: Jun. 24, 2004

(54) Hand position detecting device and electronic timepiece provided therewith

(76) Inventor: Kenji Ogasawara, Chiba-shi (JP)

Correspondence Address: ADAMS & WILKS, 31st Floor, 50 Broadway, New York, NY, 10004, US

(21) Appl. No.: 10/718,115

(22) Filed: Nov. 20, 2003

(30) Foreign Application Priority Data
Nov. 21, 2002 (JP) 2002-338292
Nov. 5, 2003 (JP) 2003-375389

(51) Int. Cl. G04B 19/04; G04B 19/06

(52) U.S. Cl. 368/80

(57) ABSTRACT

To provide a hand position detecting device capable of suppressing the rotation of hand wheels necessary to detect the initial positions of the hand wheels to a minimum, also, an electronic timepiece provided with this device. In a hand position detecting device of a hand position setting device of an electronic timepiece, light from a light-emitting device is made to obliquely hit reflective surface on an hour wheel via an aperture for passage of incident light when a minute wheel and the hour wheel reach given positions, the aperture being in the minute wheel. Reflected light Br produced by oblique reflection of the incident light at the reflective surface is detected by a light-receiving device via an aperture for passage of reflected light, the aperture being in the minute wheel. The hour wheel has the plural reflective surfaces placed at different angular intervals such that the light-receiving device receives the reflected light even when the hour wheel is in plural intermediate rotational positions other than a given position. The reflection may be vertical reflection instead of oblique reflection. Instead of reflected light, transmitted hole may be detected.

### BACKGROUND OF THE INVENTION

1. Field of the Invention

The present invention relates to a hand position detecting device for a timepiece and to an electronic timepiece provided with the device.

2. Description of the Prior Art

A hand position detecting device for detecting that hands such as second hand, minute hand, and hour hand have been once returned to their initial positions (e.g., the position of just 12 o'clock) is known in a timepiece having a radio correction function of correcting the time by receiving standard radio waves including time information. In a known structure of this hand position detecting device, a light-emitting device, a light-receiving device, and a reflective surface are so arranged that hand wheels whose rotational positions are to be detected are interposed among them. When each hand wheel reaches a given position, light from the light-emitting device is made to hit the reflective surface via the aperture in the hand wheel, and reflected light reflected by the reflective surface is detected by the light-receiving device via the aperture in the hand wheel (for example, JP-A-2000-35489 and Japanese Patent No. 2941576 (patent publication gazette)).

In these hand position detecting devices, however, the reflective surface that gives information about the initial position is present at one location and so where all of the hour wheel, minute wheel, and second wheel are rotationally driven by one motor, it is necessary to rotationally drive the hands amounts corresponding to 12 hours at maximum to set the hands to their initial positions. Furthermore, while they are being rotationally driven, it is necessary to keep electrically feeding the light-emitting and light-receiving devices, as well as the motor and its rotational driver circuit. Accordingly, the time taken to place them in their initial positions is prolonged. In addition, where the driving source is a battery, it is difficult to neglect the energy consumption.

### SUMMARY OF THE INVENTION

The present invention has been made in view of the foregoing. It is an object to provide a hand position detecting device capable of minimizing the rotation (the amount by which the motor is rotationally driven or the number of driving steps) of hand wheels necessary to ascertain their initial positions and also to provide an electronic timepiece provided with this device.

To achieve the above-described object, the hand position detecting device of the present invention in which, when first hand wheel and a second hand wheel which is rotated in response to rotation of the first hand wheel so as to make one rotation as the first hand wheel makes an integral number of rotations, have reached given positions, light from a light-emitting device is made to hit regions formed in the second hand wheel permitting light detection via an aperture formed in the first hand wheel to pass incident light and the light made detectable from the regions permitting light detection is detected by a light-receiving device. The second hand wheel has the plural regions permitting light detection, the regions being angularly unequally spaced from each other such that the light-receiving device receives the light made detectable when the second hand wheel is also at plural intermediate rotational positions other than the given positions.

In the hand position detecting device of the invention, “the hour wheel has the plural regions permitting light detection for light-receiving device to receive the light made detectable when it is also at plural intermediate rotational positions other than the given positions”. Therefore, the rotational angle of the second hand wheel or the time (the amount by which the motor is rotationally driven or the number of driving steps) required to detect the regions permitting light detection can be small. Furthermore, in the hand position detecting device of the invention, “the second hand wheel has the plural regions permitting light detection, the regions being angularly unequally spaced from each other”. Therefore, after one region permitting light detection is detected, the position of the second hand wheel can be identified simply by detecting the rotational angle of the second hand wheel necessary to detect the next region permitting light detection (typically, a region permitting light detection is detected twice). Consequently, the second hand wheel can be set in a given position or another given position having a given positional relation (angular relation) to the former given position simply by rotating the second hand wheel through an angle corresponding to the given position based on the identified position. Hence, the angle through which the hand wheel is rotated to place the hand wheel into the given position or another given position as described above can be reduced to a minimum. In addition, the time required to place the hand wheel in position as described above can be minimized. Also, the energy consumption can be reduced to a minimum. Where the timepiece is a radio-controlled timepiece or the like, the initial position typically corresponds to the given position. Instead of the given position, the initial position may also be the aforementioned another given position having a certain positional relation to the first-mentioned given position.

In the hand position detecting device of the invention, the regions of the second hand wheel permitting light detection may be either reflective surfaces that reflect incident light and produce reflected light or light transmissive regions (apertures or regions made of a light transmissive material) that transmit incident light and produce transmitted light.

In the hand position detecting device of the invention, where the regions of the second hand wheel permitting light detection are reflective surfaces, the light made detectable is reflected light. The light-receiving device is constructed to detect the reflected light reflected by the reflective surfaces via the aperture in the first hand wheel to pass reflected light. In this case, incidence and reflection may be made obliquely relative to the reflective surfaces or substantially perpendicularly to the reflective surfaces. In the hand position detecting device of the invention, where the incidence and reflection are performed obliquely relative to the reflective surfaces, the device is so constructed that when the first and second hand wheels have reached given positions, light from the light-emitting device obliquely hits the reflective surfaces on the second hand wheel via the aperture in the first hand wheel to pass incident light. Reflected light reflected obliquely by the reflective surfaces is detected by the light-receiving device via the aperture in the first hand wheel, the aperture being used for passage of reflected light. On the other hand, in the latter case, the aperture for passage of incident light and the aperture for passage of reflected light consist of the same shared aperture. When the first and second hand wheels reach the given positions, light from the light-emitting device is made to hit the reflective surfaces on the second hand wheel substantially perpendicularly via the shared aperture in the first hand wheel, the shared aperture acting as the aperture for passage of incident light. Reflected light reflected by the reflected surfaces substantially perpendicularly is detected by the light-receiving device via the shared aperture acting as the aperture in the first hand wheel for passage of reflected light.

In the hand position detecting device of the invention, where the regions of the second hand wheel permitting light detection are light transmissive regions, the light made detectable is transmitted hole passed through the light transmissive regions of the second hand wheel. The light-receiving device detects the transmitted hole from the light transmissive regions.

In the hand position detecting device of the invention, the angular interval between the regions of the second hand wheel permitting detection is set to an integral multiple of an incremental rotation angle through which the second hand wheel rotates when the first hand wheel makes one rotation.

In the hand position detecting device of the invention, the first hand wheel is typically a minute wheel and the second hand wheel is an hour wheel. However, if desired, the first hand wheel may be a second hand wheel, and the second hand wheel may be a minute wheel. Furthermore, a set in which the first hand wheel is a minute wheel and the second hand wheel is an hour wheel and another set in which the first hand wheel is a second hand wheel and the second hand wheel is a minute wheel may be combined.

In a typical hand position detecting device where the first and second hand wheels are minute wheel and hour wheel, respectively, the angular interval between the regions of the hour wheel permitting detection (typically, reflective surfaces) is typically an integral multiple of the incremental angle, i.e., 30 degrees, through which the hour wheel acting as the second hand wheel rotates when the minute wheel acting as the first hand wheel makes one rotation. In this case, the minute wheel can be set at positions shifted by amounts that are precisely integral multiples of 1 hour, i.e., at the same position as the given positions. Therefore, it is assured that it is possible to detect whether any region of the hour wheel permitting detection is in any given position where incident light from the light-emitting device is received and light made detectable is sent to the light-receiving device simply by forming the aperture in the minute wheel to pass incident light and the aperture to pass the light made detectable (typically, reflected light) only at one location. That is, in the hand position detecting device of the invention, the hour wheel is provided with the regions permitting detection, the regions being angularly spaced from each other by amounts equal to integral multiples of 30 degrees. Therefore, events permitting detection with the hour wheel such as reflection are obtained at rotational positions shifted in time by integral multiples of 1 hour. Meanwhile, the minute wheel returns to the same position in a time shifted by an integral multiple of 1 hour. Therefore, when the rotational position of the hour wheel is detected, the minute wheel is automatically placed in position. Also, where the second wheel other than the minute wheel is placed in position at the same time, the same circumstance holds. Moreover, where an intermediate wheel for mating together the hour and minute wheels and an intermediate wheel for mating together the minute and second wheels are placed in position simultaneously, the same circumstance holds.

In the hand position detecting device of the invention, the hour wheel typically has four regions (typically, reflective surfaces) permitting detection, the regions being spaced from each other in the direction of rotation. The four regions include a reference position where incident light from the light-emitting device is supplied as light made detectable (typically, reflected light) to the light-receiving device when the hour wheel is in a given position. In this case, the angular intervals between any adjacent regions ones of the four regions permitting detection are typically 30 degrees, 60 degrees, 120 degrees, and 150 degrees.

In this case, the position of the hand wheel can be identified simply by rotating the hour wheel about 180 degrees (corresponding to 6 hours) at maximum. The hand wheel can be quickly placed in position. Also, the energy consumption can be suppressed to a minimum.

The angular intervals between any adjacent regions of the four regions (e.g., reflective surfaces) permitting detection may be 30 degrees, 60 degrees, 90 degrees, and 180 degrees, instead of 30 degrees, 60 degrees, 120 degrees, and 150 degrees.

In the hand position detecting device of the invention, where it is desired to reduce the number of the regions formed on the hour wheel and permitting detection (e.g., reflective surfaces), the hour wheel may have three regions (e.g., reflective surfaces) permitting detection, the three regions being unequally spaced from each other in the direction of rotation. The three regions include a reference position where incident light from the light-emitting device is supplied as light made detectable (e.g., reflected light) to the light-receiving device when the hour wheel is in a given position.

In the hand position detecting device of the invention, where the first and second hand wheels are minute and hour wheels, typically after the first region permitting detection (such as a reflective surface) is detected by rotation of the hour wheel, the light-emitting device and light-receiving device are once stopped from being driven. Each time the hour wheel rotates for one hour, the light-emitting and light-receiving devices are driven during the time required to detect whether the light from the light-emitting device is received by the light-receiving device or not in the rotational position. In this case, the light-emitting and light-receiving devices are driven by electrically feeding them practically during a time for which the hand wheels (hour wheel and minute wheel) are required to be rotated to detect the first region permitting detection. Therefore, the consumption of energy required to drive the light-emitting and light-receiving devices can be suppressed to a minimum. Consequently, in a battery-driven case, the consumption of the battery can be reduced to a minimum. That is, when the reflective surface is detected second time, it is only necessary to perform one detection as to whether reception of light is present or not whenever a rotation corresponding to 1 hour is made. Consequently, the light-emitting and light-receiving devices are only required to be driven like sampling whenever a rotation corresponding to 1 hour is made. Thus, the consumption of energy required to drive the light-emitting and light-receiving devices can be suppressed to a negligible extent.

Where the hand position detecting device of the invention is so configured that light from the light-emitting device hits the reflective surfaces obliquely, is reflected obliquely at the reflective surfaces, and enters the light-receiving device, a V-shaped optical path is formed as a whole. If the gap or the thickness between the mounting portions of the circuit board where the light-emitting and light-receiving devices are mounted and the reflective surfaces is relatively small, the gap between the light-emitting and light-receiving devices can be made relatively large. This reduces the danger that the light-receiving device receives stray light. The incidence angle and reflection angle at the reflective surfaces are typically about 30 degrees, for example. However, as long as the light-receiving device can receive the light with sufficient strength, the angles may be about 45 degrees or about 60 degrees in some cases, or even greater. As long as the danger that a part of the light emitted from the light-emitting portion is reflected at other than the given (correct) reflective surfaces and erroneously enters the light-receiving portion as stray light does not exist in practice, the incidence angle and reflection angle may be set smaller. For example, they may be about 15 degrees or less.

Where the hand position detecting device of the invention is so configured that light from the light-emitting device hits the reflective surfaces obliquely, is reflected obliquely at the reflective surfaces, and enters the light-receiving device, the aperture for passage of incident light and the aperture for passage of reflected light are typically separated by a partitional wall portion. In this case, there is little danger that incident light passed through the aperture for passage of incident light erroneously reaches the aperture for passage of reflected light and so the danger that the light-receiving device receives stray light can be suppressed to a minimum. However, if desired, in the minute wheel or the like whose rotational position is to be detected, the aperture portion forming the aperture for passage of incident light and the aperture portion forming the aperture for passage of reflected light together way form one elongated continuous aperture. Where both minute and second wheels have the aperture for passage of incident light and the aperture for passage of reflected light and the minute wheel is located close to the hour wheel having reflective surfaces, for example, even if the aperture in the minute wheel for passage of incident light and the aperture for passage of reflected light together form one elongated continuous aperture, the second wheel located remotely from the reflective surfaces typically has two apertures separated from each other. The apertures may be holes or windows made of a material transparent to the used light.

Where the hand position detecting device of the invention is so configured that light from the light-emitting device is made to hit the reflective surfaces obliquely, is reflected obliquely at the reflective surfaces, and enters the light-receiving device, the direction in which the light-emitting and light-receiving devices are spaced from each other is set to a direction intersecting the radial direction of the minute wheel and hour wheel whose rotational positions should be detected, typically set to a direction perpendicular to the radial direction, to avoid increase of the size of the device. In this case, the space between the aperture in a rotating part such as a gear to pass incident light and the aperture to pass reflected light can be set large for the diameter of the rotating part. Hence, the space between the light-emitting device and light-receiving device can be set relatively large. This can reduce the danger that the light-receiving device receives stray light. That the direction in which the light-emitting and light-receiving devices are spaced from each other is set to intersect the radial direction of the minute wheel and hour wheel whose rotational positions should be detected (typically set to a sense perpendicular to the radial direction) means that the angle connecting the light-emitting and light-receiving devices is oblique (typically, at right angles) relative to the angle connecting the center axes of rotation of two gears in a case where the rotational positions of the two gears provided with the center axes of rotation parallel to each other are detected at the same time, for example. It is not necessary to arrange the light-emitting and light-receiving devices between the two center axes of rotation. Consequently, the size within the plane perpendicular to the axial direction of the rotational position detecting device can be suppressed to a minimum.

### BRIEF DESCRIPTION OF THE SEVERAL VIEWS OF THE DRAWINGS

A preferred form of the present invention is illustrated in the accompanying drawings in which:

FIG. 1 is a schematic functional block diagram of a watch having a hand position setting device provided with a hand position detecting device that is a preferred embodiment according to the present invention;

FIGS. 2 show explanatory views schematically showing the operation of the optical detection system of the watch of FIG. 1 for detecting initial positions; A is an explanatory view in cross section taken along line IIA-IIA of C; B is an explanatory view in planar cross section showing the arrangement of reflective surfaces on an hour wheel, as viewed along IIB-IIB of A; and C is an explanatory view in cross section (explanatory view in planar cross section) along line IIC-IIC of A;

FIG. 3 is a schematic circuit diagram showing one example of the circuit configurations of light-emitting and light-receiving portions of the hardware of FIG. 1;

FIG. 4 is a flowchart illustrating the flow of processing in a hand position setting device provided with a hand position detecting device that is a preferred embodiment according to the invention;

FIG. 5 is an explanatory plan view showing a case in which the hands of the watch of FIG. 1 are in their initial positions;

FIG. 6 show explanatory views of another preferred embodiment according to the invention, schematically showing the operation of the optical detection system in the watch of FIG. 1 for detecting the initial positions; A and B are explanatory views in cross section as viewed under the same conditions as A and B, respectively, of FIG. 2; and

FIG. 7 show explanatory views of a still other preferred embodiment according to the invention, schematically showing the operation of the optical detection system in the watch of FIG. 1 for detecting the initial positions; A and B are explanatory views in cross section as viewed under the same conditions as A and B, respectively, of FIG. 2.

### DETAILED DESCRIPTION OF THE PREFERRED EMBODIMENTS

Some preferred modes of practice of the present invention are described based on the preferred embodiments shown in the accompanying drawings.

### Embodiment 1

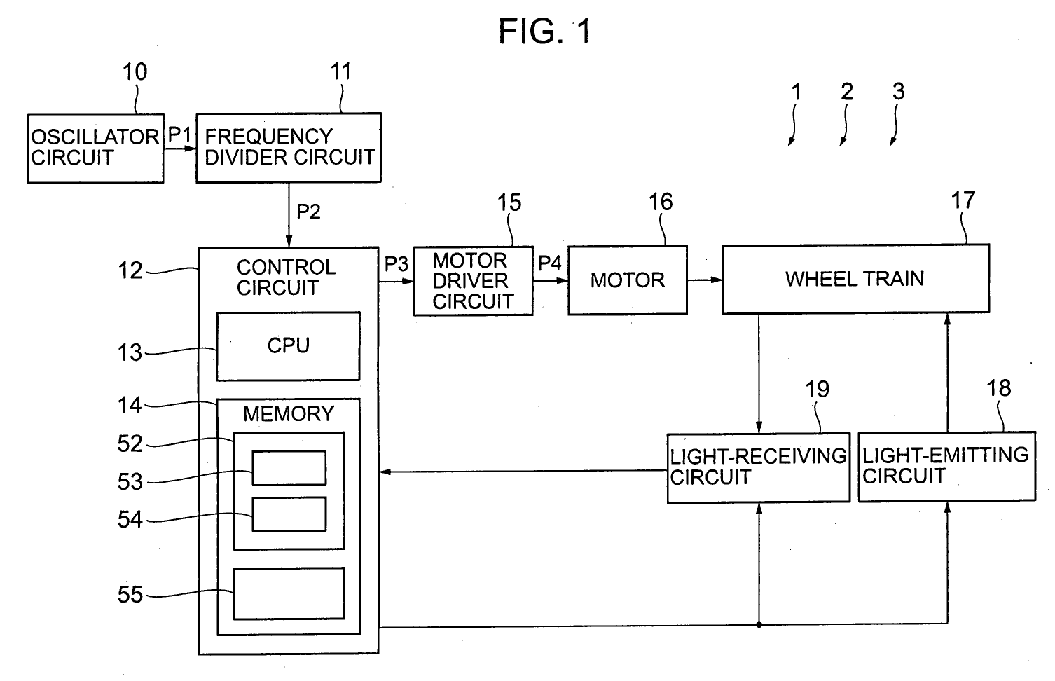

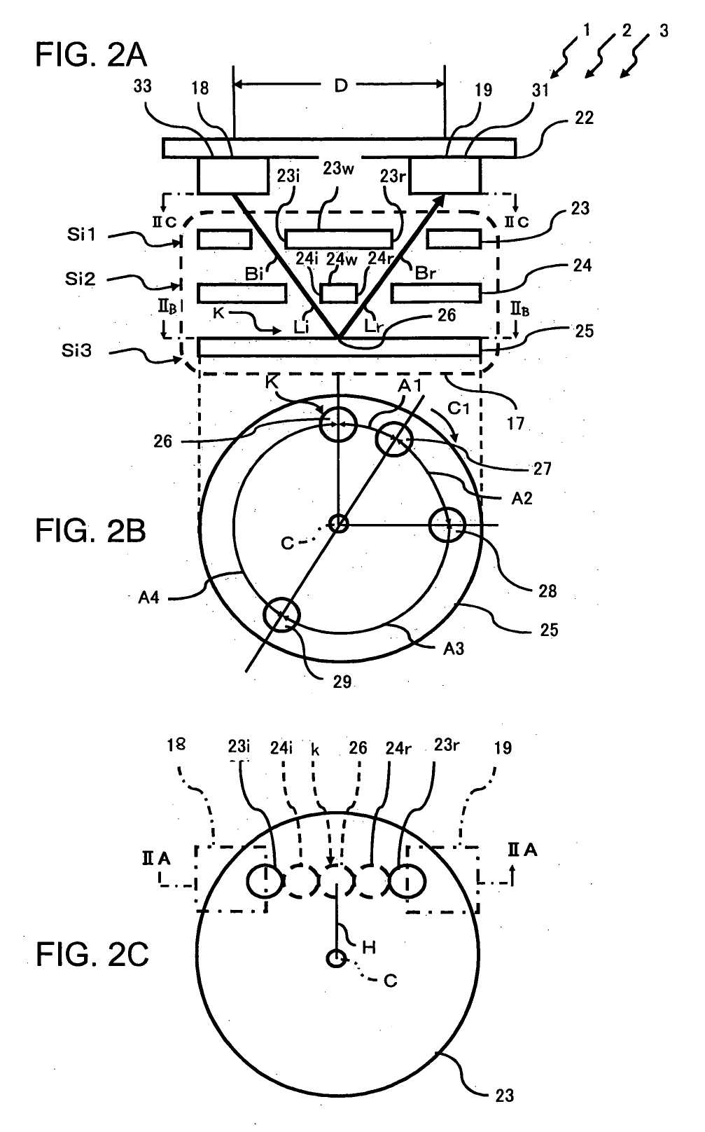

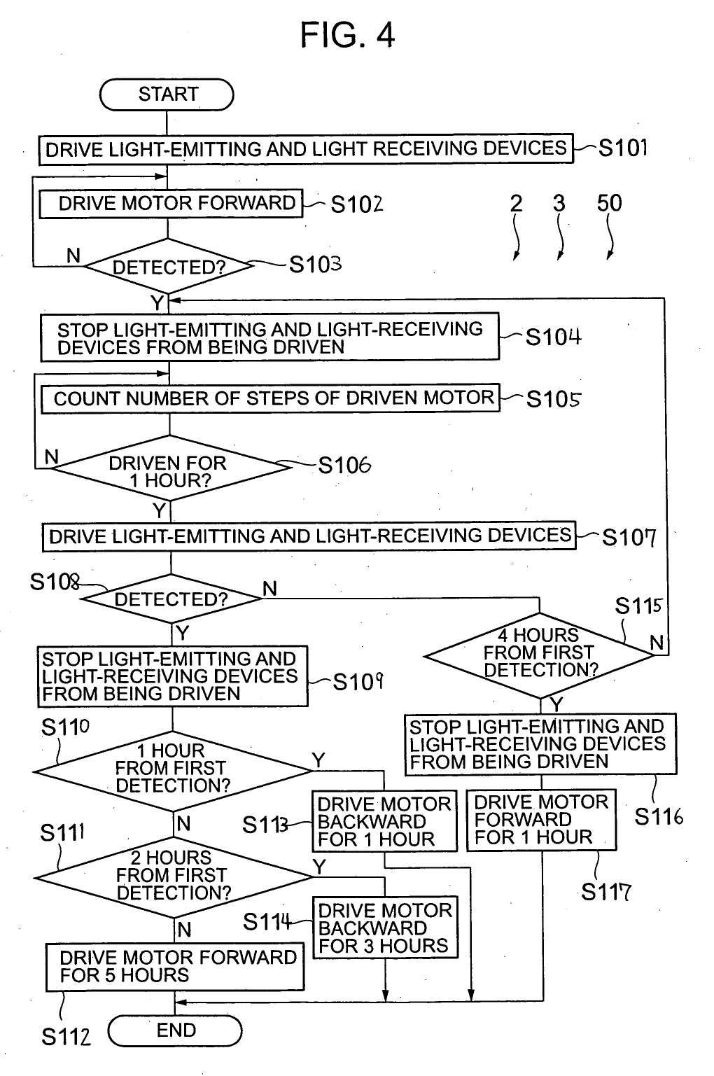

In a watch 1 that is a preferred embodiment according to the present invention, as shown in FIG. 1, a signal P1 from an oscillator circuit 10 is frequency-divided by a frequency divider circuit 11 into a pulse signal P2. Based on this pulse signal, a control circuit 12 including a microprocessor 13 and a memory 14 sends a drive-and-control signal P3 to a motor driver circuit 15. A motor 16 is rotated in accordance with a driver signal P4 owing to the motor driver circuit 15. Thus, a wheel train 17 mated to the output shaft of the motor 16 is rotated. The wheel train 17 includes intermediate wheel trains and hand wheels such as a second wheel 23, a minute wheel 24 acting as a first hand wheel, and an hour wheel 25 (FIG. 2) acting as a second hand wheel. A second hand 60, a minute hand 61, and an hour hand 62 (FIG. 5) are mounted to the second wheel 23, minute wheel 24, and hour wheel 25, respectively. The memory 14 includes a ROM (read-only memory) portion 55 loaded with a program 50 for detecting hand positions as shown in the flowchart of FIG. 4 and a RAM portion 52 becoming aworking region. A hand wheel relative position data storage portion 53 and a reflective surface interval counter 54 (described later) are formed in the RAM portion 52.

In the following description, it is assumed that the output pulses P2 from the frequency divider circuit 11 are pulses having a repetition frequency of 1 Hz during normal motion of the hands, for simplicity of illustration. The gear reduction ratio between the output shaft of the motor 16 and the second wheel 23 is 1/30. Each time the motor 16 is made to make a half rotation in a stepwise manner, the second hand 60 moves a distance corresponding to 1 second (makes a 1/60 rotation). The number of the second pulses P2 is counted by the hand wheel relative position data storage portion 53 operating as a counter for the pulses P2. That is, the contents of the hand wheel relative position data storage portion 53 correspond to the rotational positions, in seconds, of the hand wheels 23, 24, and 25, i.e., hands 60, 61, and 62, in a 1:1 relation.

The fact that the second wheel 23, minute wheel 24, and hour wheel 25 acting as hand wheels are present at initial positions Si1, Si2, and Si3 which are target positions (given positions) is detected as shown in FIG. 2.

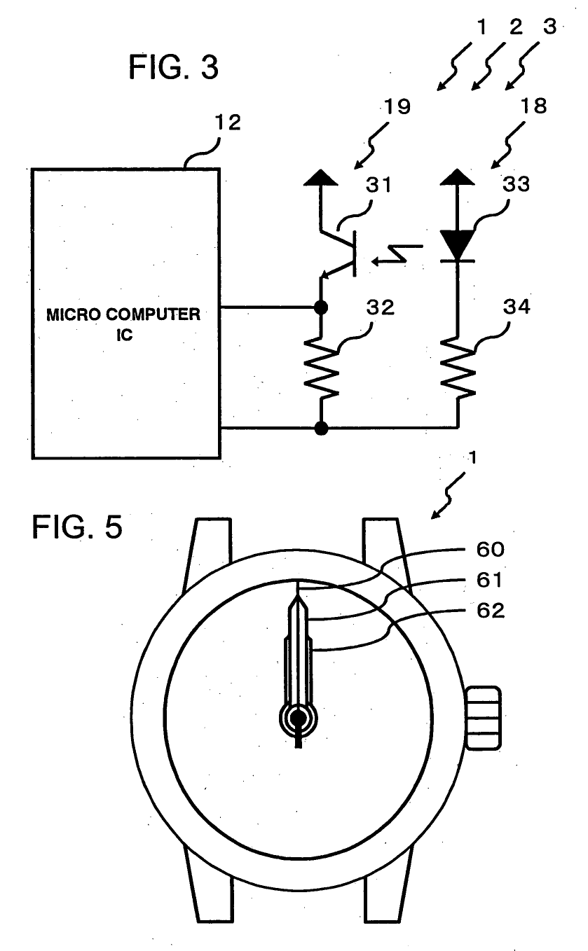

That is, as can be seen from A of FIG. 2, on a circuit board 22, for example, a light-emitting portion 18 including a light-emitting device 33 (FIG. 3) such as an LED and a light-receiving portion 19 including a light-receiving device 31 (FIG. 3) such as a phototransistor are mounted at an interval of D between these portions. Reflective surfaces 26, 27, 28, and 29 acting as regions permitting light detection are formed on the side of the hour wheel 25 that is opposite to the light-emitting portion 18 and light-receiving portion 19. The reflective surfaces are located in positions where incident light Bi incident obliquely from the light-emitting portion 18 is reflected obliquely and supplied as reflected light Br (as the light made detectable) to the light-receiving portion 19. The second wheel 23 and minute wheel 24 are respectively provided with apertures 23i, 24i for passage of incident light and apertures 23r, 24r for passage of reflected light at an interval such that an incident light path Li permitting the incident light Bi from the light-emitting portion 18 to just hit the reflective surface 26, 27, 28, or 29 obliquely is opened and, at the same time, a received light path Lr permitting the reflected light Br to come out of the reflective surface 26, 27, 28, or 29 obliquely and just enter the light-receiving portion 19 is opened when both hand wheels 23 and 24 are in the initial positions Si1 and Si2 (the positions on the hour)

As can be seen from C of FIG. 2, the angle connecting the light-emitting portion 18 and light-receiving portion 19 or the direction in which a plane defined by the incident light path Li and reflected light path Lr extends is perpendicular to the radial direction H as viewed in a plan view (plane vertical to the center axis C of rotation) as in C of FIG. 2. In other words, when the second wheel 23 and minute wheel 24 are in their respective initial positions Si1 and Si2, the angle connecting the aperture 23i in the second wheel 23 for passage of incident light and the aperture 23r for passage of reflected light and the angle connecting the aperture 24i in the minute wheel 24 for passage of incident light and the aperture 24r for passage of reflected light are substantially perpendicular to the radial direction H. The radial direction H referred to herein is the direction connecting the midpoint of each line and the center axis C, the line connecting the apertures 23i and 23r or connecting the apertures 24i and 24r.

The thickness and size of the watch 1 are suppressed to a minimum by arranging the light-emitting portion 18, light-receiving portion 19, reflective surface 26, and so on such that the incident light path Li and reflected light path Lr form a V-shaped light path having a large aperture angle and arranging the light-emitting portion 18 and light-receiving portion 19 so as to be aligned in perpendicular to the radial direction H. This permits position detection to be performed with high positional accuracy. The apertures 23i and 24i for passage of incident light are separated from the apertures 23r and 24r for passage of reflected light via wall portions 23w and 24w. This is useful in suppressing entry of stray light into the light-receiving portion 19 after a part of the light Bi coming out of the light-emitting portion 18 is reflected at other than the reflective surface (26, 27, 28, or 29) to thereby form the stray light. Also, it is useful in enhancing the resolution relative to the rotational angles of the hand wheels 23 and 24.

Of course, if desired, the aperture for passage of incident light and the aperture for passage of reflected light may be formed into one elongated continuous aperture. The direction connecting the light-emitting portion 18 and light-receiving portion 19 may intersect the radial direction H not perpendicularly but at a smaller angle. In a case where a relatively large size is tolerated, the direction may extend along the radial direction.

In the initial positions Si1, Si2, and Si3 shown at A and C of FIG. 2, the second hand 60, minute hand 61, and hour hand 62 assume the positions of just 12 o'clock as shown in FIG. 5.

Where the second wheel 23, minute wheel 24, and hour wheel 25 are in their initial positions Si1, Si2, and Si3 in this way, the light Bi from the light-emitting portion 18 passes through the light paths Li and Lr and is just detected as the reflected light Br by the light-receiving portion 19. Therefore, it is found or detected that the second wheel 23, minute wheel 24, and hour wheel 25 have reached the initial positions Si1, Si2, and Si3. It follows that the second wheel 23, minute wheel 24, and hour wheel 25 are positionally set at the initial positions Si1, Si2, and Si3.

A specific example of circuit is described in further detail by referring to the example shown in FIG. 3. The light-emitting portion 18 consists of the light-emitting diode 33 and a current-limiting resistor 34, for example. The light-receiving portion 19 consists of the phototransistor 31 and a resistor 32 for adjusting the light reception sensitivity.

As shown at B of FIG. 2, the hour wheel 25 has the fundamental reflective surface 26 at the position of just 12 o'clock. In addition, it has the reflective surfaces 27, 28, and 29 at positions which are shifted from the fundamental reflective surface 26 by 30 degrees, 90 degrees, and 210 degrees, respectively, clockwise C1. That is, the reflective surface 27 is at the position of 1 o'clock. The reflective surface 28 is at the position of 3 o'clock. The reflective surface 29 is at the position of 7 o'clock. Accordingly, the angular interval A1 between the reflective surfaces 26 and 27 is 30 degrees. The angular interval A2 between the reflective surfaces 27 and 28 is 60 degrees. The angular interval A3 between the reflective surfaces 28 and 29 is 120 degrees. The angular interval A4 between the reflective surfaces 29 and 26 is 150 degrees. The intervals A1, A2, A3, and A4 are different in size. At A of FIGS. 2, the dial (not shown) and hands are present under the figure.

Therefore, in this hand position detecting device 3, the light from the light-emitting portion 18 is reflected by the reflective surface 27, 28, or 29 and received by the light-receiving portion 19 in cases where the hour wheel 25 is in the rotational position of just 1 o'clock (i.e., the reflective surface 27 is located at the reflective position K), the hour wheel is in the rotational position of just 3 o'clock (i.e., the reflective surface 28 is located at the reflective position K), or the hour wheel is in the rotational position of just 7 o'clock (i.e., the reflective surface 29 is located at the reflective position K), as well as in the case where the hour wheel 25 is in the rotational position of just 12 o'clock(i.e., the fundamental reflective surface 26 is at the reflective position K that is just located on the incident light path Li). On the hour, the second wheel 23 and minute wheel 24 are located at the initial positions Si1 and Si2, respectively, and so it is assured that the light paths Li and Lr are opened.

Then, the flow of processing of an initial position detection program 50 is described based on the flowchart of FIG. 4, the program functioning to detect the initial positions using the hand position setting device 2 provided with the hand position detecting device 3 of a preferred embodiment of the invention constructed as described so far. The processing described in the flowchart is carried out by executing the initial position detection program 50 by means of the CPU 13, the program being loaded in the memory 14.

When a radio-controlled correction is made, if an instruction to the effect that the hands 60, 61, and 62 of the watch 1 should be returned to the initial positions of just 12 o'clock is issued, the hand position detecting device 3 itself is reset to its initial state. After this resetting to the initial state, the watch 1 enters the forced reset mode.

In the resetting of the hand position detecting device 3 itself to the initial state, the contents of the hand wheel relative position data storage portion 53 are reset to zero, for example. If desired, the contents in this reset state may be saved to other storage region such that the state taken during resetting can be reproduced.

Then, the light-emitting device 33 of the light-emitting portion 18 and light-receiving device 31 of the light-receiving portion 19 are started to be electrically fed and driven. Emission of the beam Bi from the light-emitting device 33 of the light-emitting portion 18 begins (step S101 of FIG. 4).

Then, the watch 1 enters the forced reset mode. In this forced reset mode, the repetition frequency of the pulses P2 from the frequency divider circuit 11 of FIG. 1 is increased, for example, by a factor of many tens or pulses having repetition frequencies of more than many tens of Hz of the original output from the frequency divider circuit 11 are adopted to drive the motor. The second hand 60 is forcedly rotated at a high speed of about 1 rotation/second or higher (step S102). When rotation of the hands 60, 61, and 62 is started in this forced reset mode, the contents of the hand wheel relative position data storage portion 53 have been reset. Therefore, subsequent positions of the hands 60, 61, and 62 (in other words, the positions of the hand wheels 23, 24, and 25) correspond to the counted values in the hand wheel relative position data storage portion 53 in a 1:1 relation, it being noted that the position assumed at the moment when a forced resetting operation was started is taken as the initial position (origin)

In the forced reset mode, if one pulse P2 is produced from the frequency divider circuit 11, the counted value of the hand wheel relative position data storage portion 53 is incremented by “1”. Also, the motor 16 is rotated one step via the driver circuit 15 (step S102 of FIG. 4). In response to the stepwise rotation of the motor 16 in one step, the second wheel 23 of the wheel train 17 rotates an amount corresponding to 1 second. Also, the minute wheel 24 coupled to the second wheel 23 via the wheel train and the hour wheel 25 coupled to the minute wheel 24 via the wheel train rotate amounts corresponding to 1 second.

Under the state in which the hand wheels 23, 24, and 25 of the wheel train 17 have rotated amounts corresponding to 1 second in this way, a check is performed as to whether the light-receiving portion 19 has received the reflected light Br which has been emitted from the light-emitting portion 18 and reflected by a reflective surface (step S103).

Where the light-receiving portion 19 does not receive the light from the light-emitting portion 18, the program goes back to step S102, where the motor 16 is again rotationally driven one step forwardly. In the state taken after this rotation through an angle corresponding to 1 second, a check is made as to whether the light-receiving portion 19 has detected the reflected light Br (step S103). This driving of the motor 16 for forward rotation (step S102) and the check performed by the light-receiving portion 19 as to whether detection of light is done or not (step S103) are repeatedly carried out until the light-receiving portion 19 detects the reflected light Br from any one of the reflective surfaces 26, 27, 28, and 29.

When the second wheel 23 and minute wheel 24 reach positions on the hour (i.e., the apertures 23i and 24i for passage of incident light are aligned to thereby open the incident light path Li and the apertures 23r and 24r for passage of reflected light are aligned to thereby open the reflected light path Lr) and, at the same time, the hour wheel 25 reaches the rotational position of just 0 (12) o'clock, just 1 o'clock, just 3 o'clock, or just 7 o'clock (i.e., anyone of the reflective surfaces 26, 27, 28, and 29 is located at the reflective position K that should be the intersection of the incident light path Li and reflected light path Lr), the light Bi coming out of the light-emitting portion 18 passes through the incident light path Li, reaches the reflective surface 26, 27, 28, or 29, is reflected by the reflective surface 26, 27, 28, or 29, and forms the reflected light Br that passes through the reflected light path Lr. This reflected light reaches the light-receiving portion 19, where the light is detected. Therefore, the reflective surface interval counter 54 is reset to zero. The program exits from the step S103 with YES. The light-emitting device 18 and light-receiving device 19 are once stopped from being driven (step S104).

This reflective surface interval counter 54 counts the relative amount of rotation R of the motor 16 rotationally driven after detection of any one of the reflective surfaces 26, 27, 28, and 29 at an accuracy of 1 second, the relative amount of rotation R being expressed in terms of time or in hours. Then, the motor 16 is driven forwardly at high speed until the counted value of the reflective surface interval counter 54 reaches 1 hour (e.g., 3,600) (steps S105 and S106)

When rotational driving corresponding to 1 hour is completed, the light-emitting device 33 of the light-emitting portion 18 and the light-receiving device 31 of the light-receiving portion 19 are again driven (step S107). A check is made as to whether the light Br from the light-emitting portion 18 is received by the light-receiving portion 19 (step S108).

In particular, in steps S105 to S108, whenever the motor 16 is rotationally driven an amount corresponding to 1 hour, the light-emitting device 33 and light-receiving device 31 are driven, and it is checked whether the light Br from the light-emitting device 18 is received by the light-receiving portion 19 (whether any one of the reflective surfaces 26, 27, 28, and 29 has reached the reflective position K that is the intersection of the incident light path Li and reflected light path Lr). During this interval, the reflective surface interval counter 54 counts how many hours for which the motor 16 has been rotated.

After the first 1-hour rotational driving, when the program first reaches the step S108, if the light-receiving portion 19 detects the light Br, the program exits from the step S108 with YES and stops the light-emitting device 33 and light-receiving device 31 from being driven (step S109). Then, the program enters step S110, where the contents of the reflective surface interval counter 54 are shown to be 1 hour. Since 1 hour has passed since the first detection, the program exits from the step S110 with YES. The reflective surfaces located at intervals of 1 hour are only the reflective surface 26 located at the position of just 12 o'clock and the reflective surface 27 located at the position of just 1 o'clock. Therefore, it can be seen that the reflective surface 27 produces the second reflection at this moment. Accordingly, in step S113, the motor 16 is reversely driven an amount corresponding to 1 hour to return the hour wheel 25 to the position of just 12 o'clock (step S114). Thus, positional resetting to the initial positions is completed.

On the other hand, after the first 1-hour rotational driving, if the light Br is not detected by the light-receiving portion 19 on reaching step S108, a check is performed as to whether the time elapsed since the first detection has reached 4 hours by referring to the contents of the reflective surface interval counter 54 (step S115).

In this case, only one hour has passed and so the program exits from the step S115 with NO and returns to the step S104, where the light-receiving device 31 and light-emitting device 33 are once stopped from being driven.

Subsequently, the motor 16 is rotationally driven an amount corresponding to 1 hour (steps S105 and S106). Then, the light-receiving device 31 and light-emitting device 33 are driven, and a check is performed as to whether the light is received by the light-receiving portion 19 (step S108).

Where the light-receiving portion 19 detects the light Br, skip the step S108 with YES and stop the light-emitting device, 33 and light-receiving device 31 from being driven (step S109) and enter the step S110, where it is found from the contents of the reflective surface interval counter 54 that 2 hours have passed since the first detection. Therefore, skip the step S110 with NO, enter step S111, and skip the step S110 with YES. Since the reflective surfaces located at intervals of 2 hours are only the reflective surface 27 at the position of just 1 o'clock and the reflective surface 28 at the position of just 3 o'clock, it is seen that the reflective surface 28 located at the position of just 3 o'clock produces the second reflection at this moment. Accordingly, in step S114, the motor 16 is rearwardly driven an amount corresponding to 3 hours, and the hour wheel 25 is returned to the position of just 12 o'clock. Thus, positional resetting to the initial positions is completed.

After it is rotationally driven an amount corresponding to 2 hours after the first detection, if the light Br is not detected by the light-receiving portion 19 on reaching the step S108, a check is performed as to whether the amount of rotational driving after the first detection has reached an amount corresponding to 4 hours (step S115). The program exits from the step S115 with NO and returns to the step S104, where the light-receiving device 31 and light-emitting device 33 are once stopped from being driven.

Then, the motor 16 is further rotationally driven an amount corresponding to 1 hour (steps S105 and S106). The light-emitting device 33 and light-receiving device 31 are driven, and a check is performed as to whether the light is received by the light-receiving portion 19 (step S108).

Since it is unlikely that the light Br is detected by the light-receiving portion 19 after 3 hours from the first detection, skip the step S108 with NO and enter the step S115. Furthermore, skip the step S115 with NO and again return to the step S104, stop the light-receiving device 31 and light-emitting device 33 once from being driven.

Thereafter, the motor 16 is further rotationally driven an amount corresponding to 1 hour (steps S105 and S106). The light-emitting device 33 and light-receiving device 31 are driven, and a check is performed as to whether the light is received by the light-receiving portion 19 (step S108). At this instant, the contents of the reflective surface interval counter 54 are 4 hours.

Where the light Br is detected by the light-receiving portion 19, skip the step S108 with YES, the light-emitting device 33 and light-receiving device 31 stop from being driven (step S109)and enter the step S110, where 4 hours have passed since the first detection. Therefore, skip the step S110 with NO and then skip step S111 with NO. Since the reflective surfaces located at intervals of 4 hours are only the reflective surface 28 located at the position of just 3 o'clock and the reflective surface 29 located at the position of just 7 o'clock, it can be seen that the reflective surface 29 in the position of the just 7 o'clock produces the second reflection at this instant. Accordingly, in step S112, the motor 16 is forwardly driven an amount corresponding to 5 hours, and the hour wheel 25 is moved into the position of just 12 o'clock. Thus, positional resetting to the initial positions is completed.

On the other hand, where the light Br is not detected by the light-receiving portion 19, it follows that the light-receiving portion 19 detects nothing even after the motor is rotationally driven for 4 hours after the first detection. Therefore, skip the step S115 with YES, and the light-receiving device 31 and light-emitting device 33 stop from being driven (step S116). Since the reflective surfaces located at intervals corresponding to more than 4 hours are only the reflective surface 29 at the position of just 7 o'clock and the reflective surface 26 at the position of just 12 o'clock, it can be seen that the motor is located at a position rotated from the position of just 7 o'clock by an amount corresponding to 4 hours, i.e., at the position of just 11 o'clock, at this instant. Therefore, the motor 16 is further rotationally driven an amount corresponding to 1 hour from the position of this just 11 o'clock (step S117). The hour wheel 25 is moved into the position of just 12 o'clock. Thus, positional resetting to the initial positions is completed.

In the description provided so far, where the first reflective surface is the reflective surface 26 at the just 12 o'clock, the motor is rotationally driven an average amount corresponding to 2.5 hours to detect the reflective surface 26. Then, the motor is rotationally driven an amount corresponding to 1 hour to detect the second reflective surface 27. Therefore, the motor is rotationally driven an average amount corresponding to 3.5 hours as a whole.

On the other hand, where the first reflective surface is the reflective surface 27 at just 1 o'clock, the motor is rotationally driven an average amount corresponding to 0.5 hour to detect the reflective surface 27. Then, the motor is rotationally driven an amount corresponding to 2 hours to detect the second reflective surface 28. Therefore, the motor is rotationally driven an average amount corresponding to 2.5 hours as a whole.

Furthermore, where the first reflective surface is the reflective surface 28 at just 3 o'clock, the motor is rotationally driven an average amount corresponding to 1 hour to detect the reflective surface 28. Then, the motor is rotationally driven an amount corresponding to 4 hours to detect the second reflective surface 29. It follows that the motor is rotationally driven an average amount corresponding to 5 hours as a whole.

In addition, where the first reflective surface is the reflective surface 29 at just 7 o'clock, the motor is rotationally driven an average amount corresponding to 2 hours to detect the reflective surface 29. Then, the motor is rotationally driven an amount corresponding to 4 hours to detect that the second reflective surface 26 is not reached. Consequently, the motor is rotationally driven an average amount corresponding to 6 hours as a whole.

As described so far, this watch 1 is provided with the plural reflective surfaces 26, 27, 28, and 29 which are spaced from each other by different angular intervals A1, A2, A3, and A4. Therefore, it is possible to determine where the initial position is present simply by rotating the hour wheel 25 about one half turn at maximum. Consequently, the initial position can be determined quickly. Furthermore, in this watch 1, the reflective surfaces are at positions on the hour. Therefore, after the first reflective surface is detected, the initial position can be determined simply by driving the light-emitting device 33 and light-receiving device 31 for a short time whenever the amount of rotation of the hour wheel 25 becomes an integral multiple of an amount corresponding to 1 hour. In consequence, the energy consumption can be suppressed to a minimum.

Instead of placing the reflective surface 29 at the position of just 7 o'clock, for example, it may be placed at the position of just 6 o'clock, for example. In this case, the angular interval A3 is 90 degrees (corresponding to 3 hours). The angular interval A4 is 180 degrees (corresponding to 6 hours). In this case, in order to detect or ascertain the second reflective surface 29 after finding the first reflective surface 28, rotation corresponding to 3 hours suffices. That is, in step S115 of FIG. 4, a decision or evaluation is made in 3 hours instead of 4 hours. The average time (amount of rotation or the number of driving steps of the motor) required to determine the position in a case where the second reflective surface is the reflective surface at just 6 o'clock is 1 hour+3 hours=4 hours. The average time (amount of rotation or the number of driving steps of the motor) taken to determine the position in a case where the first reflective surface is the reflective surface at just 6 o'clock is 1.5 hours+3 hours=4.5 hours. Note that where the first reflective surface is the reflective surface at just 12 o'clock, the average time taken to determine the position is 3 hours+1 hour=4 hours.

If the condition is limited to the condition where reflection on the hour is detected, it is impossible to place five or more reflective surfaces that are unequally spaced from each other. Although the time taken to detect or ascertain the position is prolonged, three reflective surfaces may be placed at unequal angular intervals if desired. For example, a combination of just 12 o'clock, just 1 o'clock, and just 3 o'clock (for simplicity of illustration, this is given by (0, 1, 3) here) may be possible. Also, (0, 1, 4), (0, 1, 5), (0, 1, 6), (0, 2, 5), (0, 2, 6), or (0, 3, 7) may be possible. In the case where information about the time (amount of rotation or the number of driving steps of the motor) taken until a reflective surface is detected for the first time is not used for position detection, if the order of combination of the same angular intervals is varied, a substantially equivalent result arises. Therefore, its description is omitted.

In the watch 1 shown in the embodiment described so far, the rotational position is ascertained after 4 hours from the first reception and detection of the light. Therefore, the hands can be moved from the ascertained rotational positions to arbitrary given positions. Accordingly, in the description of the embodiment described so far, it has been assumed that the reflective surface 26 is at the position of just 12 o'clock. As long as the reflective surfaces 26, 27, 28, and 29 are at positions on the hour (i.e., when the hour wheel is at a position on the hour, the reflective surfaces 26, 27, 28, and 29 supply the light Bi from the light-emitting device 18 as the reflected light Br to the light-receiving portion 19), the reflective surface 26 does not need to be at a position of just 12 o'clock. In some cases, it may be at a position not on the hour. However, if the convenience of checking again that the hour wheel 25 is set at the position of just 12 o'clock, for example, is taken into account, there is preferably a reflective surface at the position of just 12 o'clock.

Furthermore, in the flowchart of FIG. 4, information about the amount of rotation of the driven motor in step S102 before the rotational position where the first reflection is obtained is reached is not used. However, where the motor is rotated an amount corresponding to more than 4 hours based on the counted value of the hand wheel relative position data storage portion 53 and a reflective surface is first detected (in a case where the counted value exceeds 4 hours), for example, arrival at the reflective surface 26 is ascertained unconditionally. Where a reflective surface is first detected after the motor is rotated an amount corresponding to more than 2 hours, it is ascertained that the reflective surface 26 or 29 has been reached. Therefore, in the latter case, if a second reflective surface is not detected after the motor is further rotated an amount corresponding to 1 hour, it is ascertained that the first reflective surface is the reflective surface 29 (in a case where a second reflective surface is detected after rotating the motor an amount corresponding to 1 hour, the first reflective surface is the reflective surface 27 in the same way as the flow of steps S108, S110, and S113 of FIG. 4). In this way, the rotational position of the hour wheel 25 may be ascertained with a smaller amount of rotation for driving by making use of information about the amount of rotation given to the motor in step S102 until, the rotational position where the first reflection is obtained is reached. In this case, instead of gradually increasing the interval expressed in terms of time or in hours using the reflective surface 26 as a reference such as 1, 2, 4, and 5, it is possible to reduce the amount of rotation necessary to ascertain the position by alternating greater and smaller intervals such as (1, 4, 2, 5) or (1, 5, 2, 4). However, the average time for which the light-emitting device 33 and light-receiving device 31 are driven is substantially dependent on the amount of driving necessary to detect the first reflective surface and, therefore, approximately the same in practice.

### Embodiment 2

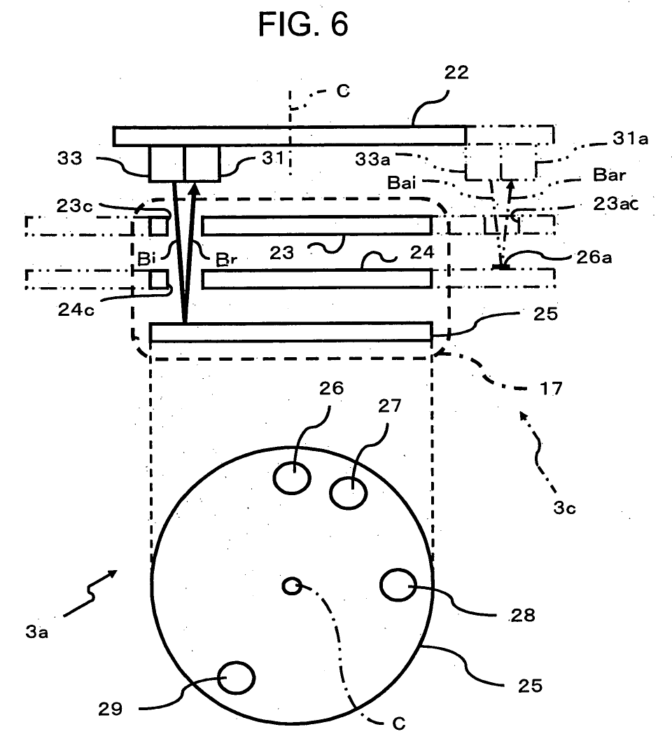

In the description of the embodiment provided so far, the light-emitting device 313 and light-receiving device 31 are placed at an interval of D. The light Bi from the light-emitting device 33 obliquely hits the reflective surface 26 or the like through the apertures 23i and 24i for passage of incident light. The reflected light Br produced by oblique reflection from the reflective surface 26 or the like is received by the light-receiving device 31 via the apertures 23r and 24r for passage of reflected light. That is, an example of oblique incidence and oblique reflection has been described. Instead, the structure may be constructed as shown in FIGS. 6.

In the hand position detecting device 3a of FIGS. 6, the light-emitting device 33 and light-receiving device 31 are placed close to each other such that they can be placed substantially just opposite to the reflective surface 26 or the like. The second wheel 23 has the shared aperture 23c acting as the aperture for passage of incident light and as the aperture for passage of reflected light. The minute wheel 24 similarly has the shared aperture 24c acting also as the aperture for passage of incident light and as the aperture for passage of reflected light.

Accordingly, in this hand position detecting device 3a, in a case where the second wheel 23, minute wheel 24, and hour wheel 25 are in the initial positions Si1, Si2, Si3, and so on, the light Bi from the light-emitting device 33 passes-through the shared apertures 23c and 24c acting as the aperture for passage of incident light and substantially perpendicularly hits the reflective surfaces 26, 27, 28, 29, etc. on the hour wheel 25. The reflected light Br produced by substantially perpendicular reflection at the reflective surfaces 26, 27, 28, 29, and so on passes through the shared apertures 23c and 24c acting also as the aperture for passage of reflected light and is received by the light-receiving device 31 located close to the light-emitting device 33. Except that the optical path from the light-emitting device 33 to the light-receiving device 31 is different from that of the hand position detecting device 3 as in FIGS. 2, this hand position detecting device 3a is configured substantially similarly to the hand position detecting device 3 in other respects.

### Embodiment 3

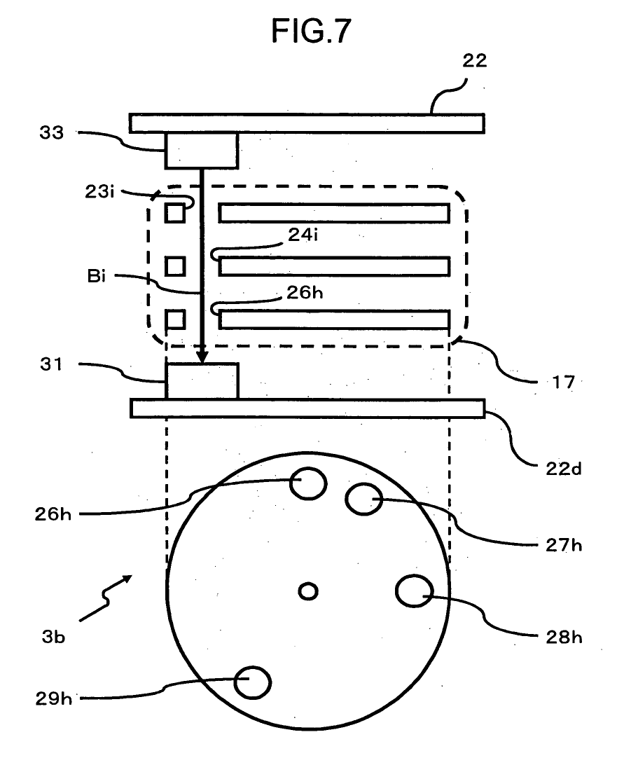

Furthermore, in the description of the embodiment provided so far, the regions of the hour wheel 25 permitting light detection are the reflective surfaces on the hour wheel 25. The regions of the hour wheel 25 permitting light detection may be light transmissive regions as shown in FIG. 7 instead of reflective surfaces.

In the hand position detecting device 3b of FIG. 7, the hour wheel 25 has apertures 26h, 27h, 28h, and 29h acting as light transmissive regions in the same positions as the reflective surfaces 26, 27, 28, and 29 instead of these reflective surfaces 26, 27, 28, and 29. The device has a circuit board 22d for detection. The light-receiving device 31 is mounted on the circuit board 22d on the opposite side of the wheel train 17 from the circuit board 22.

Accordingly, in this hand position detecting device 3b, in a case where the second wheel 23, minute wheel 24, and hour wheel 25 are in the initial positions Si1, Si2, Si3, etc., the light Bi from the light-emitting device 33 passes through the apertures 23i and 24i in the second wheel 23 and minute wheel 24 for passage of incident light and through the apertures 26h, 27h, 28h, 29h, etc. in the hour wheel 25, and is received by the light-receiving device 31 that is placed just opposite to the light-emitting device 33 on the circuit board 22d on the rear side of the hour wheel 25. This hand position detecting device 3a differs from the hand position detecting device 3a of FIG. 6 in that the regions of the hour wheel 25 permitting light detection are formed by apertures instead of reflective surfaces and that the light-receiving device 31 is mounted, instead of the circuit board 22, on the circuit board 22d on the opposite side of the wheel train 17. Except for these points, the hand position detecting device 3a is constructed substantially similarly to the hand position detecting device 3a of FIG. 6 in other respects.

In the description of the embodiments provided so far, all the hand wheels are rotated by one motor via wheel trains. Where synchronization can be taken regarding rotational driving of the motor when the structure is reset to its initial condition, the wheel trains may be rotated by plural motors.

### Embodiment 4

For example, in FIG. 6, an additional set of light-emitting device 33a and light-receiving device 31a may be provided at a different distance from the center of rotation C on the circuit board 22 as indicated by the imaginary lines. Also, another shared aperture 23ac capable of acting as the aperture for passage of incident light and as the aperture for passage of reflected light may be formed in the second wheel 23 at a given angular position and at a radial position where the incident light Bai and reflected light Bar between the light-emitting device 33a and light-receiving device 31a can be passed. Moreover, reflective surfaces 26a and so on similar to the reflective surfaces 26, 27, 28, and 29 of the hour wheel 25 may be formed on the minute wheel 24 at desired angular intervals at given angular positions and at radial positions where the surfaces can be placed just opposite to the shared aperture 23ac.

In the hand position detecting device 3c constructed in this way, the second wheel 23 acts as the first hand wheel while the minute wheel 24 acts as the second hand wheel in the relation with the light-emitting device 33a and light-receiving device 31a. Accordingly, in the above-described embodiment, if the light-receiving device 31a detects that the second wheel 23 and minute wheel 24 have arrived at given reference positions in the relation with the light-emitting device 33a and light-receiving device 31a in the same way as in the case where the light-receiving device 31 detects that the minute wheel 24 acting as the first hand wheel and the hour wheel 25 acting as the second hand wheel have arrived at given angular positions in the relation with the light-emitting device 33 and light-receiving device 31, then the positions of the second wheel 23 and minute wheel 24 can be detected in a short time from the amount of rotation or the like occurring until the next given reference positions for the second wheel 23 and minute wheel are detected by rotating the second wheel 23 at high speed. Therefore, based on this information about detection, the position on the hour, for example, can be identified in a short time. Based on the position on the hour, the position of the hour wheel 25 can be identified at high speed in the relation with the light-emitting device 33 and light-receiving device 31. In this case, the second wheel 23 does not need to be associated with the set of light-emitting device and light-receiving device 33, 31. For example, the radius of the second wheel 23 may be smaller than the radii of the other wheels 24 and 25. For instance, the second wheel 23 or a wheel corresponding to it may not be concentric with the minute wheel 24 or hour wheel 25.

The arrangement of such two sets of light-emitting and light-receiving devices, their associated apertures for passage of incident light, regions permitting light detection, and so on is not limited to the embodiment of FIGS. 6. Similar arrangement may be adopted in the embodiments of FIGS. 2 and 7. In this case, similar kinds may be combined out of oblique reflection as in FIG. 2, vertical reflection as in FIGS. 6, and transmission as in FIG. 7 regarding the two sets of light-emitting and light-receiving devices. Also, two dissimilar kinds may be combined.

What is claimed is:

1. A hand position detecting device comprising:
a first hand wheel;
a second hand wheel which is rotated in response to rotation of the first hand wheel so as to make one rotation as the first hand wheel makes an integral number of rotations;
a light-emitting device which is made to hit regions formed in the second hand wheel permitting light detection via an aperture formed in the first hand wheel to pass incident light, when the first hand wheel and the second hand wheel have reached given positions;
a light-receiving device to detect light made detectable from the regions permitting light detection;
wherein the second hand wheel has the plural regions permitting light detection, the regions being angularly unequally spaced from each other such that the light-receiving device receives the light made detectable when the second hand wheel is at plural intermediate rotational positions other than the given positions.

2. A hand position detecting device set forth in claim 1, wherein the regions of the second hand wheel permitting light detection are reflective surfaces and the light made detectable is reflected light, and wherein the light-receiving device detects the reflected light reflected by the reflective surfaces via the aperture in the first hand wheel to pass reflected light.

3. A hand position detecting device set forth in claim 2, wherein when the first and the second hand wheels have reached the given positions, the light from the light-emitting device is made to obliquely hit the reflective surfaces on the second hand wheel via the aperture in the first hand wheel to pass incident light, and wherein reflected light reflected by the reflective surfaces obliquely is detected by the light-receiving device via the aperture in the first hand wheel to pass reflected light.

4. A hand position detecting device set forth in claim 2, wherein the aperture to pass incident light and the aperture to pass reflected light consist of a common shared aperture, when the first and the second hand wheels have reached the given positions, the light from the light-emitting device is made to hit the reflective surfaces on the second hand wheel substantially perpendicularly via the shared aperture in the first hand wheel, the shared aperture acting as the aperture to pass incident light, and reflected light reflected substantially perpendicularly at the reflective surfaces is detected by the light-receiving device via the shared aperture acting as the aperture in the first hand wheel to pass reflected light.

5. A hand position detecting device set forth in claim 1, wherein the regions of the second hand wheel permitting light detection are light transmissive regions, the light made detectable is transmitted hole passed through the light transmissive regions of the second hand wheel, and the light-receiving device detects the transmitted hole from the light transmissive regions.

6. A hand position detecting device set forth in claim 1, wherein the angular interval between the regions of the second hand wheel permitting detection is an integral multiple of an incremental rotation angle through which the second hand wheel rotates when the first hand wheel is rotated once.

7. A hand position detecting device set forth in claim 1, wherein the first hand wheel is a minute wheel, while the second hand wheel is an hour wheel.

8. A hand position detecting device set forth in claim 7, wherein the angular interval between the regions of the hour wheel permitting detection is an integral multiple of 30 degrees.

9. A hand position detecting device set forth in claim 7, wherein the hour wheel has four regions permitting detection including a reference position at which incident light from the light-emitting device is supplied as the light made detectable to the light-receiving device when the hour wheel is at a given position, the four regions being arranged in the direction of rotation, and wherein the angular intervals between adjacent regions of the four regions permitting detection are 30 degrees, 60 degrees, 120 degrees, and 150 degrees.

10. A hand position detecting device set forth in claim 7, wherein the hour wheel has four regions permitting detection including a reference position at which incident light from the light-emitting device is supplied as the light made detectable to the light-receiving device when the hour wheel is at a given position, the four regions being arranged in the direction of rotation, and wherein the angular intervals between adjacent reflective surfaces of the four regions permitting detection are 30 degrees, 60 degrees, 90 degrees, and 180 degrees.

11. A hand position detecting device set forth in claim 7, wherein after a first one of the regions permitting detection is detected by rotation of the hour wheel, the light-emitting device and the light-receiving device are once stopped from being driven, and wherein each time the hour wheel rotates for an hour, the light-emitting device and the light-receiving device are driven during a time taken to detect whether the light from the light-emitting device is received by the light-receiving device or not in the rotational position.

12. An electronic timepiece compirsing:
a hand position detecting device;
wherein the hand position detecting devic is comprised a first hand wheel, a second hand wheel which is rotated in response to rotation of the first hand wheel so as to make one rotation as the first hand wheel makes an integral number of rotations, a light-emitting device which is made to hit regions formed in the second hand wheel permitting light detection via an aperture formed in the first hand wheel to pass incident light, when the first hand wheel and the second hand wheel have reached given positions, a light-receiving device to detect light made detectable from the regions permitting light detection, wherein the second hand wheel has the plural regions permitting light detection, the regions being angularly unequally spaced from each other such that the light-receiving device receives the light made detectable when the second hand wheel is at plural intermediate rotational positions other than the given positions.
